(19) United States
(12) Patent Application Publication
(10) Pub. No.: US 2026/0358521 A1
(43) Pub. Date: Nov. 12, 2026

(54) A METHOD AND SYSTEM FOR DETERMINING GROUND PROPERTIES OF A SUB-SURFACE TARGET VOLUME USING A 2-DIMENSIONAL ARRAY OF SURFACE WAVE SENSORS

(71) Applicant: FNV IP B.V., Leidschendam (NL)

(72) Inventors: Moritz FLIEDNER, Leidschendam (NL); Myrna STARING, Leidschendam (NL); Rod EDDIES, Leidschendam (NL)

(73) Assignee: FNV IP B.V., Leidschendam (NL)

(21) Appl. No.: 19/137,615

(22) PCT Filed: Dec. 18, 2023
(86) PCT No.: PCT/EP2023/086454

§ 371 Date: Jun. 10, 2025

(30) Foreign Application Priority Data
Dec. 23, 2022 (NL) 2033830

(51) Int. Cl. G01V 1/30; G01V 1/28

(52) U.S. Cl. CPC G01V 1/305; G01V 1/282; G01V 1/284

(57) ABSTRACT

A method of determining ground properties of a sub-surface target volume using a 2 dimensional array of surface wave sensors, comprises determining a plurality of velocity dispersion profiles as a function of sensed surface wave frequency; generating a 3 dimensional phase velocity dispersion profile from the plurality of phase velocity dispersion profiles; determining a plurality of group velocity dispersion profiles as a function of sensed surface wave frequency; generating a plurality of respective shear wave velocity models as a function of depth from the 3 dimensional phase velocity dispersion profile and each group velocity dispersion profile; and generating a 3 dimensional shear wave velocity model as a function of depth from the plurality of respective shear wave velocity models. Unlocking insights from Geo-Data, the present invention further relates to improvements in sustainability and environmental developments: together we create a safe and livable world.

### TECHNICAL FIELD

The disclosure relates to methods and systems for analysing a target region beneath a surface of the earth. More particularly, the disclosure relates to a method and system for determining one or more ground properties of the sub-surface target region based on ambient noise measured at or near the surface. In particular the disclosure relates to a method and system for determining ground properties of a sub-surface target volume using a 2-dimensional array of surface wave sensors. Unlocking insights from Geo-Data, the present invention further relates to improvements in sustainability and environmental developments: together we create a safe and livable world.

### BACKGROUND

There is a general and ongoing need for systems and methods for determining sub-surface ground parameters. In particular, there is a need for systems and methods that can be used to model the properties of a target volume beneath the surface of the earth to provide the information useful for infrastructure planning. Determination of sub-surface ground properties during the early planning phase of construction projects reduces uncertainty during the location determination, foundation design, and construction phases of a project. This in turn reduces delays, overspend, and unnecessary use of material resources (e.g. concrete) during construction.

One key parameter for the determination of ground characteristics in a volume of interest is shear-modulus and shear-velocity Vs. The shear velocity Vs is the velocity at which a shear wave moves through the material and is controlled by the shear modulus of the material. The relationship between shear-velocity and shear modulus G is defined by Vs=√G/ρ, where ρ is the density of the material. Measurement of Vs therefore provides a valuable insight to the ground properties of a sub-surface ground region. Small-strain shear modulus (Gmax) is also important in foundation design, wherein Gmax=ρ·Vs².

Spectral analysis of surface waves (SASW) and multi-channel analysis of surface waves (MASW) are both examples of techniques for gathering surface wave information that can be used in the determination of ground properties in a sub-surface volume. In both of these techniques, surface-level vibrations resulting from an active source (e.g. a weight drop) are measured from and the dispersion of the resulting surface waves is studied. ReMi (Refraction Microtremor) is another surface-level technique that uses ambient noise and surface waves to infer ground properties of a sub-surface region based on the observation of ambient noise at the surface.

Down-hole and cross-hole techniques can also be used to determine ground properties of a sub-surface region. In both of these methods, a receiver located in a bore hole measures waves received from an active source located elsewhere. In a down-hole technique, one of the source and the receiver is located at a sub-surface location within the bore hole and the other of the source and the receiver is located at the surface. In a cross-hole technique, a source is located in a first bore hole, with a receiver located in a second bore hole. In both down-hole techniques, the propagation and dispersion of the received waves are studied to infer the properties of the material through which the waves from the receiver have travelled.

Invasive techniques for measuring material ground properties of a sub-surface region can often present logistical challenges such as long duration of the processes and thus low cost efficiency, e.g. long process set-up, long acquisition times and/or heavy machinery, equipment and processes. Invasive techniques are often particularly undesirable, especially in urban or inaccessible environments, and are often prohibitively expensive. Invasive techniques may also be unfriendly to the environment, e.g. cause disturbance to the local fauna. Conversely, current surface-level techniques may lack the accuracy and reliability of more invasive analysis techniques.

For example known approaches employ a distributed 2D grid of surface wave sensors to provide a 3D Vs distribution, however existing solutions are resolution limited.

### Overview

According to the invention there is provided method of determining ground properties of a sub-surface target volume using a 2 dimensional array of surface wave sensors, the method comprising determining a plurality of velocity dispersion profiles as a function of sensed surface wave frequency; generating a 3 dimensional phase velocity dispersion profile from the plurality of phase velocity dispersion profiles; determining a plurality of group velocity dispersion profiles as a function of sensed surface wave frequency; generating a plurality of respective shear wave velocity models as a function of depth from the 3 dimensional phase velocity dispersion profile and each group velocity dispersion profile; and generating a 3 dimensional shear wave velocity model as a function of depth from the plurality of respective shear wave velocity models. As a result an improved resolution 3D shear wave Vs velocity model can be provided.

Optionally the group velocity dispersion profiles comprise 1 dimensional group wave velocity dispersion profiles.

Optionally the respective shear wave velocity models comprise 1 dimensional shear wave velocity models.

Optionally each group velocity dispersion profile is determined by measuring the time of flight between a source and a receiver.

Optionally the source and receiver comprise synthetic transmission nodes and the group velocity is determined through cross correlation of the received noise.

Optionally the respective shear wave velocity models are generated by a joint inversion of the 3 dimensional phase velocity dispersion profile and each group velocity dispersion profile.

Optionally the joint inversion comprises iteratively modifying a phase and group predicted profile to obtain a best match against the actual determined phase and group profiles for a corresponding target volume region.

Optionally the plurality of phase velocity dispersion profiles are created as a function of frequency.

Optionally each respective shear wave velocity model is generated for a sensing location from the 3 dimensional phase velocity dispersion profile and the group velocity dispersion profile for the sensing location.

Optionally the surface wave sensors are one of geophones, velocimeters or accelerometers.

Optionally the sensed surface waves are at least one of ambient or actively generated surface waves.

According to the invention there is further provided a computer readable medium comprising instructions, that, when executed by one or more data processing apparatus, cause the one or more data processing apparatus to perform the method, and a system comprising one or more processors arranged to implement the computer readable medium instructions.

### BRIEF DESCRIPTION OF THE DRAWINGS

Disclosed implementations will now be described by way of example to illustrate aspects of the disclosure and with reference to the accompanying drawings, in which:

FIG. 1 shows a cross-sectional view of a sub-surface target region;

FIG. 2 shows a plurality of geophones arranged in a 2D array at a surface above a sub-surface target region;

FIG. 3 shows a 3D model of shear-wave velocity in a sub-surface target region;

FIG. 4 shows a flow diagram setting out steps according to the disclosed method;

FIG. 5 shows a block diagram of a computing device;

FIG. 6 shows a perspective view of a shear wave velocity model;

FIG. 7 is a schematic diagram of a method for determining a surface wave group velocity model;

FIG. 8 is a schematic diagram of a method for determining one or more physical properties of a subsurface target volume; and

FIG. 9 is a schematic diagram of a method for determining one or more physical properties of a subsurface target volume.

### DETAILED DESCRIPTION

The present disclosure describes systems and method for determining the ground properties of a sub-surface volume. Although, it will be appreciated that the methods herein may be applied to model physical properties other than shear velocity, such as compressional wave velocity, density, elastic modulus, or, if a viscoelastic model is being used, optionally also viscosity coefficients Qₛ and Qn. In general, the model may define multiple physical property values, the focus of the following detailed description will be the determination of shear velocity, and the related quantity, shear modulus.

Shear modulus is a measure of the elastic shear stiffness of a material and represents the deformation of a solid when it experiences a force parallel to one of its surfaces while its opposite face experiences an opposing force. Such forces and their effects in sub-surface ground volumes, are an important parameter for study before and during the design of building and infrastructure projects. To determine the shear modulus of a volume, the shear velocity, Vs, is determined. This in turn gives an indication of the stiffness of the sub-surface material, and its ability to support structures extending above and/or through the volume.

In the context of ground study, two types of waves are generally distinguished: P-waves, in which particles in the volume oscillate in the direction of movement of the wave, cause a compression and de-compression of the ground as the waves propagate through the ground. S-waves are shear waves, in which particles oscillate in a direction perpendicular to the direction of propagation of the waves.

P-waves and S-waves are body waves and propagate in all directions through the body of the volume. The interaction of P- and S-waves with the earth's surface generates surface waves, which propagate along that surface. Several types of surface waves can be distinguished. In the systems and methods described herein, Rayleigh waves are measured and studied because it is convenient to measure the vertical component of surface vibrations. However, it will be appreciated that other surface waves (e.g. Love waves) may be measured and harnessed in the systems and methods described herein.

Because surface waves propagate in 2D (at the surface), they attenuate less rapidly than body waves (which propagate in 3D). Surface waves are generally present within a depth range of one wavelength from the surface, generally travel more slowly and have a predominantly lower frequency than body waves. This lower attenuation, slower travel time and lower frequency of surface waves makes their study particularly attractive for the purposes of determining shear velocity, Vs. Since the surface waves have lower attenuation, the signal strength is better maintained through over a longer travel distance. The resulting measurement results therefore generally have a higher signal quality (signal-to-noise ratio) than body wave studies.

The methods and systems of the present disclosure harness the study of surface waves to provide insight into the ground properties of a sub-surface target volume. In general terms, the present disclosure provides methods for analysing one or more ground properties, such as the shear-wave velocity, Vs, of a sub-surface target region. The method involves receiving a data set indicative of ambient noise at a surface above a sub-surface target region, analysing the background wavefield to study the dispersive behaviour of the surface waves measured at the surface, and determining the ground properties of the sub-surface target region based on the study of the dispersive behaviour of the observed waves.

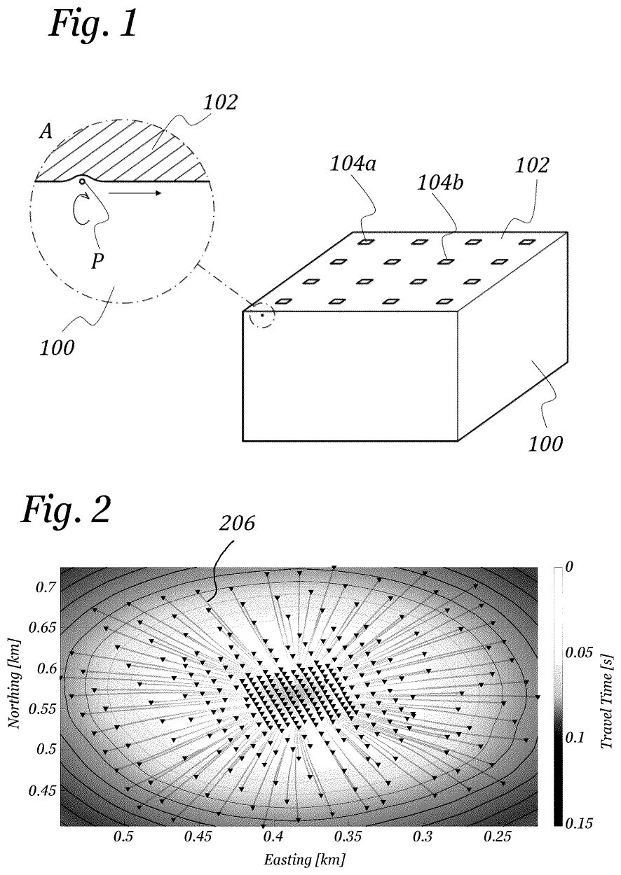

Referring now to FIG. 1, a cross-sectional view of a sub-surface volume 100 is shown. A surface 102 extends above the sub-surface volume. Surface waves propagate along the surface 102, as shown at point A, where a schematic representation of a particle oscillation (due to Rayleigh wave propagation) at the surface above the target sub-surface volume is shown. As illustrated, the oscillation of the particle P is partly vertical, partly in the direction of propagation and movement is therefore substantially ellipsoid.

At a surface 102 above the volume 100, a plurality of receivers 104a, 104b is arranged in a 2D array. The receivers (collectively referred to as 104) may be geophones configured to measure the vertical component of the surface waves propagating across the surface 102. However, it will be appreciated that the propagation of surface waves may also be measured with alternative sensing means, for example: accelerometers, seismometers, vibration sensors, and/or transducers.

The receivers 104 are configured to measure ambient noise. That is, the wavefield present due to background noise (as opposed to noise from an active source such as a hammer drop or explosion). The background noise may be natural (e.g. due to lapping ocean waves, wind, and other naturally occurring vibrations) or cultural (e.g. due to human activity, including traffic, machinery, etc.). As shown in FIG. 1, the receivers 104 are arranged in a grid array at the surface, the grid extending in two directions. It should be noted that the surface above the target region may, in many cases, not be planar. The array of receivers 104 may therefore not be truly “2-dimensional” (each receiver may be offset from its neighbours in the grid in the z-direction, as well as the x- and y-directions). However, such a grid arrangement of receivers will be referred to as a 2D array herein. It will also be appreciated that in the context of sub-surface ground study, the term 2D array may also be used to denote an array configured to capture 2D information (e.g. a line of receivers configured to provide information regarding a 2D slice of a target region) and a 3D array may refer to a grid of receivers configured to capture 3D information. However, in the context of the present information, the term 2D in the context of receivers is intended to refer to the 2-dimensional configuration of the receivers rather than the information gathered.

Moreover, although the receivers 104 are shown at the surface in FIG. 1, the receivers 104 may also be disposed near the surface (e.g. partially buried, or immediately beneath the surface). In the context of the present application, ‘at the surface’ will be understood to mean at or near the surface, such that the receivers measure surface waves.

In the schematic shown in FIG. 1, the receivers 104 are arranged in a regular grid, with the inter-receiver distance equal across surface 102. However, in some implementations, the receivers 104 are arranged with varying density across the surface 102.

The array of receivers 104 shown in FIG. 1 can be used to gather a data set indicative of ambient noise at a surface above a sub-surface target region for which a model of shear velocity Vs is desired that is the subject of the present application.

To determine the shear velocity from the observation of surface waves (in particular Rayleigh waves), the dispersive behaviour of the surface waves is studied. Surface waves are dispersive, i.e. their velocity is dependent on frequency. Since seismic velocities increase with depth in the earth, normal surface wave dispersion shows a decrease of surface-wave velocity with increasing frequency. It is by studying the behaviour of surface waves at a surface above a volume that the ground properties of the volume can be determined.

There are two ways to measure the velocity of dispersive surface waves and a distinction is made between the determination of group velocity or phase velocity.

The group velocity of a wave is the velocity with which the overall envelope shape of the wave's amplitudes—known as the modulation or envelope of the wave—propagates through space. The group velocity is equivalent to the speed with which the energy of the wave propagates through the volume and is measured by determining the wave propagation between two points. The group velocity is obtained as a time-of-flight (that is, travel time) measurement between a (virtual) source and a receiver.

The phase velocity is the velocity at which the phase of any one frequency component of the wave travels. As such, the phase velocity is expressed as a function of frequency. To measure the phase velocity, at least two measurement nodes (e.g. receivers) are chosen to measure the waves propagating through the volume to determine relative time-of-flight between the nodes for different frequencies. The result is the phase velocity as a function of frequency as averaged over the volume between the two measurement nodes. Phase velocity is acquired as a point in 2D phase space (dispersion spectrum) which is itself obtained by a 2D transform (such as slant-stack, Radon, FK, or the like) of an array of recorded waveforms (time-distance space). The wavelength of the surface wave is indicative of its propagation depth. As a result, the phase velocity as a function of frequency is indicative of the shear velocity Vs as a function of depth.

The receivers 104 at surface 102 provide the measurement nodes for the study of the surface wave behaviour as described above. However, the receivers 104 described above are configured to record passive noise. Therefore, the measurement nodes of FIG. 1 do not represent a real point source and associated receiver. However, receivers 104 can act as a virtual source receiver pair, as explained below.

Receivers 104a and 104b form a first receiver pair in the array at surface 102. Neither receiver 104a nor 104b represents a point source for noise recorded at the other of receiver 104a, 104b. However, by cross-correlating the received signal at receiver 104a and 104b, receivers 104a and 104b can act as a (virtual) source receiver pair, where each receiver of the pair records a signal as though the signal had originated at the other of the pair. The cross-correlation is performed using the principle of interferometry.

The cross-correlation of passive noise measured at respective pairs of geophones at the surface shown in FIG. 1 can be used to reproduce a response from the sub-surface target volume, as if it were induced by an impulse point source, which is equal to Green's function.

In other words, a response that is received by cross-correlating two receiver recordings can be interpreted as a response that would have been measured at one of the receiver locations as if there were a source at the other. Various approaches to determining the Green's function for a virtual source-receiver pair are known, with an overview of the approaches described in “Tutorial on Seismic Interferometry: Part 1—Basic Principles and Applications”; GEOPHYSICS. Vol. 75, No 5 (September-October 2010; P. 75A 195075A209; Wapenaar et al).

In FIG. 1, only one pair of receivers is labelled (104a, 104b). However, it will be appreciated that for each receiver 104 in the array, every other receiver in the array may act as the other half of a source receiver pair. In this manner, the Green's function for each source receiver pair may be obtained. The Green's functions across the plurality of virtual source receiver pairs is studied to determine the dispersive behaviour of the surface waves.

FIG. 2 shows a plurality of virtual source-receiver pairs across a surface above a sub-surface region of interest. Ray paths 206 between source-receiver pairs are indicated. Note that the ray paths here indicate the propagation of a wave (modelled from) a virtual source at a receiver in a centre of the plot to each of the other receivers in the array. The receivers are not labelled individually but are represented with an inverted triangle in the plot. Each receiver can similarly act as a point source. As can be seen from FIG. 2, the array of receivers allows source receiver pairs defining ray paths that extend in different directions, and with varying inter-receiver spacing. The background shading and contour rings indicate the travel-time field from the central receiver to the other receivers 104. There are also corresponding ray paths between each receiver and all other receivers, i.e. between every pair of receivers. These ray paths are not depicted in FIG. 2 for simplicity.

Following acquisition of data indicative of ambient noise, and the analysis of said ambient noise data to model a plurality of response signals at a plurality of virtual source-receiver pairs, the received data may now be used to determine the ground properties of the sub-surface target volume by solution of an inverse problem, in which the response at the receivers (e.g. receivers 104) is known but the ground properties of the sub-surface target volume is not (yet) known.

The starting model for the solution of the inverse problem may be determined in multiple ways since it sets initial physical property values, for example for Vs, within the sub-surface target volume, to be refined by solution of the inverse problem. The starting model can comprise historical data based on known local or regional data, predicted values based on selective invasive test methods, coarse surface level studies or a theoretical model based on local or regional historical knowledge. Although the starting model is to be improved upon and need not be a particularly accurate representation of the sub-surface target region, the more accurately the starting model reflects the physical properties of the sub-surface target region, the more accurate the final model of the ground properties of the target region will be. Therefore, improvements in the starting model can provide an improved output for the methods and systems described herein.

Once a starting model has been selected, the inverse problem can be solved via inversion in which a model of shear wave velocity against depth is iteratively improved to obtain a best match (for example using least squares, deterministic or gradient descent techniques) of the predicted dispersion curve from the starting model (obtained for example using forward modelling for example through the Haskell Thomson matrix approach) against the curve determined from measurements. Various techniques are well known for inversion operations as will be apparent to the skilled reader. It will be noted that this 1D derivation of shear velocity from surface wave velocity has to assume horizontal homogeneity (shear wave velocity as a function of depth only), hence the limited dimensionality.

According to known approaches, a 3D distribution can be obtained by generating (overlapping, depending on source-receiver offset range needed) rectangular patches of receiver and assigning the 1D dispersion curve to the centre of each patch.

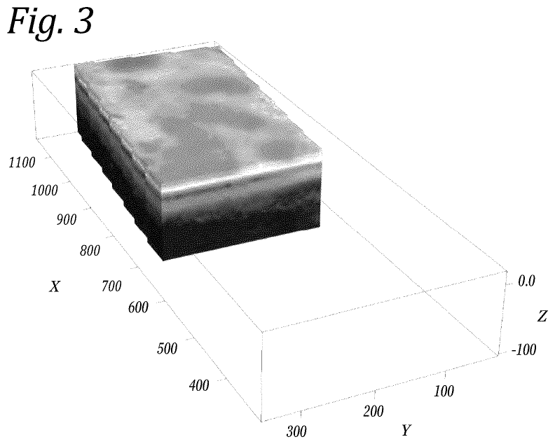

FIG. 3 shows a 3D shear-wave velocity Vs model for a sub-surface target of interest. The axes of the map indicate distance in the x, y and z directions. The shear-wave velocity Vs, is indicated by the shading, as indicated with the key on the right-hand side of the plot.

Although the model is shown here as a block for a 3D volume of interest, it will be appreciated that horizontal slices may be viewed, or that that the model view may be manipulated to show material within the sub-surface target volume having target material properties. For example, the model can be used to isolate and display a target layer of interest within the target volume.

The generation of dispersion curves showing the phase velocity as a function of frequency may provide a preliminary three-dimensional model of the shear velocities in a 3D model. However, since the acquisition of the phase velocity is essentially an average frequency-dependent velocity between measurement nodes, the resolution of this model is relatively low. Simply stacking the geophones closer together has limitations since the geophones must be positioned over sufficient distance to get a clear phase spectrum to identify different surface wave modes. As such, the phase velocity dispersion curves have an inherent resolution limitation.

In overview, the present disclosure achieves enhanced resolution by making use of both phase velocity dispersion and group velocity dispersion data. A 3 dimensional phase velocity dispersion profile is generated from the velocity dispersion profiles for example in the manner described above, creating a 3D distribution generated from overlapping patches. One or more group velocity dispersion profiles are determined, for example 1D profiles per target volume region or sensing location using the techniques described above. A respective shear wave velocity Vs model is generated as a function of depth from the 3 dimensional phase velocity dispersion profile and each group velocity dispersion profile, for example creating a plurality of 1D models of shear wave group velocity as a function of depth per target volume region or sensing location. This can be performed for example by a joint inversion of the group and phase velocities. A 3 dimensional shear wave velocity model can then be generated as a function of depth from the plurality of shear wave velocity models, generated from overlapping patches as discussed above. Enhanced resolution is additionally provided by virtue of the combination of local averages from the group velocity dispersion, which is determined over a source/receiver distance and the phase velocity dispersion which is based on bulk data over a greater spatial extent.

The present approach hence uses the preliminary three-dimensional model based on phase velocities as a starting point and a tomographic distribution of the one-dimensional models derived from individual group travel time measurements along the ray paths connecting (virtual) sources and receivers. The data received at seismometers are used to solve an inverse problem, wherein the locations of velocity-depth functions along surface wave paths are determined. This solution is used to create 3D images of velocity anomalies which may be interpreted as structural, thermal, or compositional variations. The approach hence derives a 3D sub-surface model of seismic shear-wave velocity (Vs) for geotechnical application (to derive ground stiffness distributions and soil classification) by recording, in an embodiment, passive seismic data (ambient noise) using a dense array of seismic receivers (geophones) although an actively generated signal can equally be used.

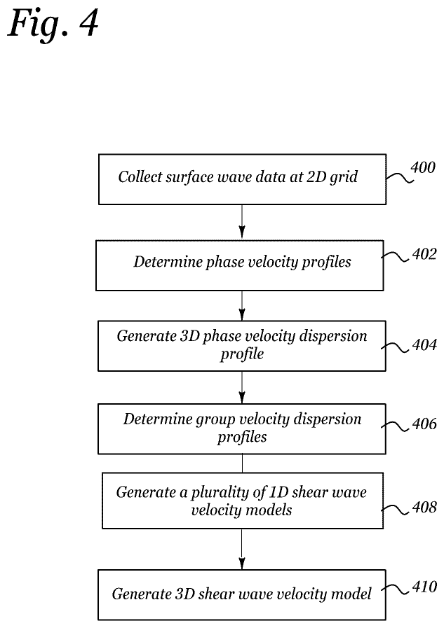

Referring to FIG. 4 implementation of the method according to the current disclosure can be understood in more detail. At step 400 surface wave data such as passive or ambient data (noise) or actively generated noise or surface wave is collected at each of the sensors, for example geophones, velocimeters or accelerometer, in the 2D array on the target section of soil or other sub-surface formation. In one embodiment the geophones can contain a ferromagnetic mass on a spring moving within an electric coil in response to the shaking of the ground inducing an electric current proportional to the ground velocity.

At step 402 phase velocity profiles are determined in the manner described above or alternative approaches which will be known to the skilled reader, for example phase spectra derived with FK and Radon (pf) transforms, between one or more virtual noise sources and one or more geophones to create a plurality of phase velocity dispersion profiles as a function of frequency based on the sensed data. Each profile is thus representative of a measure of phase velocity as a function of frequency averaged over the spatial area spanned by the geophones, allowing a shear velocity model to be created as a function of soil depth for the relevant area.

At step 404 a 3D phase velocity dispersion profile is generated in the manner described above by stitching, combining or overlapping the individual phase velocity profiles to create a distribution in the horizontal (x,y) plane against frequency using arrays of geophones to determine the dispersion curve more accurately.

At step 406 surface wave group velocity is determined from the sensed data in the manner described above based on real or virtual/synthetically generated nodes such as transmission nodes. In one approach the group velocity is determined through the generation of synthetic transmission nodes through cross correlation of the received noise, creating at least one virtual noise source using Green's functions or noise correlation functions in the manner described above and well known to the skilled reader. Hence a surface wave group velocity can be determined by measuring the time of flight between a source and a receiver sensor or geophone. This data can be collected to permit determination of group velocity in any region where sensors are in operation.

At step 408 a plurality of 1D models of shear wave velocity are generated as a function of target volume depth. As discussed above the shear wave velocity is indicative of energy propagation velocity in the soil in the region spanned by the source and receiver, and the 1D models are derived from the measured group velocity at each sensor pair, and the phase velocity dispersion data for the same segment. This is done by an inversion process of the type described above, iteratively refining an initial target volume model to obtain a best match of predicted and actual (observed) dispersion profile (function, curve), where the predicted (modelled) profile may be achieved using an appropriate approach such as least squares/gradient descent or Markov chain Monte Carlo simulation and forward modelling performed according to any appropriate process, to find a solution of the (visco)elastic wave equation for the surface wave In particular a joint inversion process is performed based on the phase velocity for the relevant spatial area obtained from the 3D phase velocity model and the group velocity for the same spatial area. The inversion process can then be performed seeking a best match for both (phase and group) predicted profiles against the actual determined profiles using known approaches such as least squares, deterministic or gradient descent approaches and calculating likelihood (in embodiments using Monte Carlo simulation) with 1D forward modelling operators such as Haskell-Thomson matrix or equivalent to relate shear wave velocity to energy propagation velocity.

At step 410a 3D shear wave velocity model is generated as a function of three spatial coordinates by stitching, combining or overlapping the individual 1D models to create a distribution of velocities in (x,y,z) which can be mapped to underlying target volume properties in the manner discussed above.

As explained above, the present disclosure can allow for an improved method of determining ground properties of a subsurface target region. The measured variable is surface vibrations at a surface above the subsurface target region. From the measured values, the material properties of the ground can determined. The measured values are compared to expected values for a given starting model (the forward problem) and the starting model is updated until the ground properties reflect the observed data (inverse problem). One or more inversion steps are used to solve the inverse problem. Although the inversion step(s) per se are not the focus of the present disclosure, by way of additional background information, methods for determining ground properties of a sub-surface target region based on the observed wavefield at the surface will be described below.

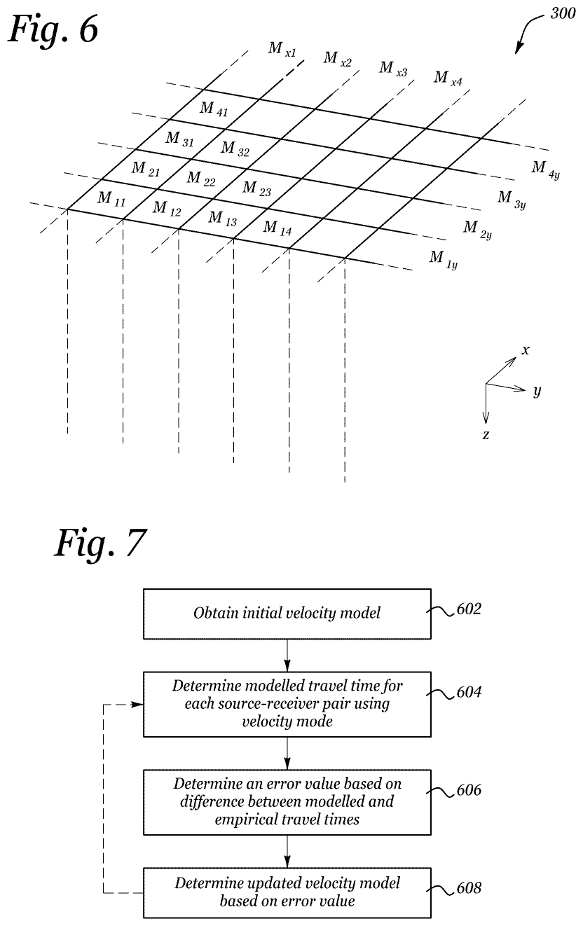

A stitched or overlapping 3D model generation process can further be understood with reference to FIG. 6 in which a first shear wave velocity model 300 has a grid of cells m_{xy} (or target volume regions, or sensor locations) across the surface above the subsurface target volume, comprising columns mₓ₁, mₓ₂, mₓ₃, etc. extending in the x-direction and rows m_{1y}, m_{2y}, m_{3y}, etc extending in the y-direction. Each cell defines an area of the surface. For example, each cell may define a 5 m by 5 m square; other example options include a 1 m by 1 m square, or a 10 m by 10 m square. In other words, the shear wave velocity model comprises a plurality of cells arranged in a two-dimensional grid 300. The two-dimensional grid spans at least the area of the surface above the subsurface target volume. Choosing a smaller cell area increases the resolution of the model. Each cell also includes a volume extending vertically below the area of the surface. The model 300 may extend infinitely below the area of the surface or to a predetermined depth below the surface for which the shear wave velocity value has a notable influence on the propagation of surface waves propagating on the surface. For example, the model 300 may be defined up to a depth of 50 m, 100 m, 200 m or 300 m.

In some examples, the first shear wave velocity model 300 is not a grid of square cells but instead comprises cells having a rectangular shape, a rhombic shape or otherwise tessellating shapes including non-uniform shapes or a combination of different shapes.

Each cell is associated with a shear wave velocity value, an example of a physical property value, which represents the expected value of shear wave velocity in the actual subsurface target volume of interest. The shear wave value carries depth information, either in that the shear wave value is constant throughout the volume below the cell area or in how the shear wave value varies with depth (the z direction in FIG. 3). For example, the defined shear wave value for each cell may be explicitly a function of depth, either a continuous function or a series of values with associated ranges of depth for each value. In another example, the shear wave velocity value may be a function of frequency, which corresponds to depth information because surface wave propagation is influenced by the physical properties of the subsurface volume up to approximately one wavelength depth. In other words, surface waves at low frequencies are affected by physical properties at deeper depths than surface waves at high frequencies.

In other examples, the model may a physical property other than shear wave velocity, such as compressional wave velocity, density, elastic modulus, shear modulus, or, if a viscoelastic model is being used, optionally also viscosity quality factors Qₛ and Qₚ. In general, the model may define multiple physical property values.

In some examples, the tomographic inversion step involves process 600 depicted in FIG. 7. FIG. 7 illustrates a method for carrying out traveltime tomography for each source-receiver pair As described in more detail below, this process tomographically maps the traveltime information from each source-receiver pair into the cells of the physical property model. The result of the process is therefore an empirical model of group and/or phase velocity (depending on the traveltime data used), with each cell of the model having a respective group or phase velocity value. This process 600 is carried out for each of a plurality of frequencies to obtain group or phase velocity values for each cell for each frequency. Process 600 is the first stage (i.e. the tomography stage) of a two-stage tomographic inversion.

Process 600 comprises a step 602 of obtaining an initial velocity model. The initial velocity model comprises initial values of group velocity and/or phase velocity for each cell for each of a plurality of frequencies. The initial velocity model sets initial (group or phase) velocity values for each cell (for each given frequency), which the process 600 will refine using the empirical traveltime data in an iterative process. Accordingly, it is not essential for the initial velocity model and respective initial velocity values to be a highly accurate or high-resolution, although a more accurate initial model may render the tomographic process 600 faster or more accurate at mapping traveltimes to each cell. A more accurate initial model may also reduce the risk of finding a local-minimum rather than a global minimum in the iterative gradient-descent method, although such an issue can be solved using Monte-Carlo methods. In some examples, the initial velocity model is determined based on a user input, e.g. according to historic data or map information indicating possible physical property values across the subsurface target volume. Alternatively, an arbitrarily chosen typical value of the group/phase velocity can be used for each cell as a starting point. In these examples, the arbitrary model may be selected based on an estimation of the physical properties of the subsurface target volume.

The tomographic process 600 further comprises the step 604 of determining modelled group or phase travel times for each of the selected source-receiver pairs using the initial group or phase velocity model. This is carried out by identifying the wave path from the source to the receiver (for example as a straight ray, curved ray or elliptical/curved Fresnel zone) and identifying the cells that are traversed by the wave path. The modelled traveltime based on the initial velocity model is then determined based on the known distance between the source and receiver and the velocity values of each cell traversed by the wave path.

The tomographic process 600 further comprises the step 606 of determining an error value indicative of the difference between the modelled travel times (determined at step 604) and the empirical traveltimes (obtained at step 504) for each of the selected source-receiver pairs. For example, the error value could be a simple difference between the modelled and empirical traveltimes, also called a residual, at each frequency for each source-receiver pair. In some examples, the error value could be a combination of all the differences between modelled and empirical traveltimes for every source-receiver pair. In general determining the error value is part of an iterative process, for example, in a least-squares inversion method where the squares of the residuals are calculated in order to be minimised through iterations. Other forms of inversion processes use different error values in order to provide feedback to the initial group velocity model.

The process 600 further comprises the step 608 of determining an updated velocity model using the error value. The updated model is generally in all aspects the same as the initial velocity model except for new velocity values associated with at least some of the cells. In other words, the updated model is an updated version of the initial velocity model taking into account the determined error value between the empirical and modelled group or phase traveltimes for each source-receiver pair. This feedback process may involve a least-squares method, Markov-chain Monte Carlo method or other inversion technique to iteratively update the initial model based on an updated model. Process 600 may be repeated for each of a plurality of finite frequencies.

Steps 604 to 608 are typically all part of a subroutine of the first-stage tomographic process 600, which is then iterated according to the inversion method such as least-squares inversion. The iterative nature of the process 600 is illustrated by the dashed arrow in FIG. 7, which indicates that the updated model determined at step 608 is used to determine new modelled traveltimes for each source-receiver pair at step 604. In other words, each time an updated model is determined using the error value resulting from the initial model and resulting modelled traveltimes for each source-receiver pair, the resulting updated model is then used as the initial model for the next iteration. The iteration continues until the error value reaches an end condition, for example, the error value falling below a threshold absolute value of the difference between the modelled and empirical traveltimes, or falling below a threshold of proportional difference between the modelled and empirical traveltimes. Another end condition, which could be used alone or in combination with the threshold error value end condition, is that the changes to the initial model to produce the updated model for an iteration falls below a threshold amount or proportion. This is so that if the iteration reaches a settled minimum error value, the iteration can end as further iterations will not make significant accuracy improvements.

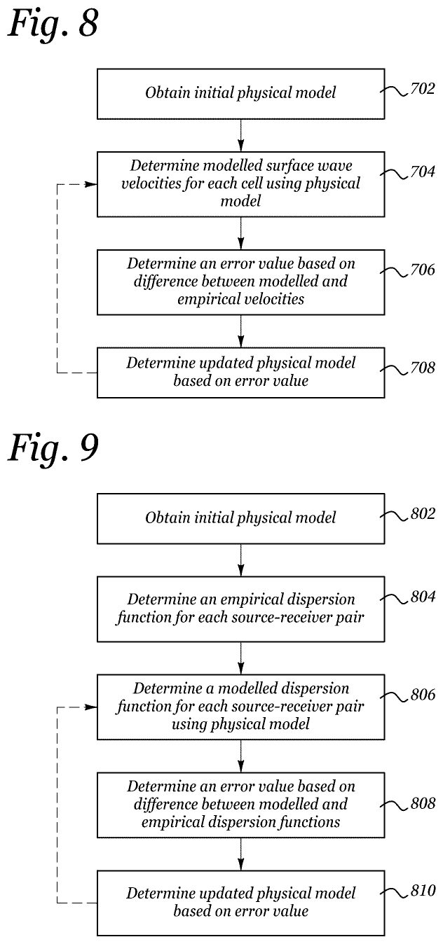

Once the tomography of the first-stage process 600 has been carried out to obtain a velocity model comprising a group or phase velocity value for each cell (for each frequency), the tomographic inversion can proceed to the second-stage (the inversion) of the two-stage tomographic inversion to obtain the resultant model of the physical property of the target subsurface volume. The second-stage inversion process 700 is depicted in FIG. 8. As with the first-stage tomographic process 600, the second stage inversion process 700 is carried out for each of a plurality of frequencies to obtain group or phase velocity values for each cell for each frequency.

The inversion process 700 comprises a first step 702 of obtaining an initial physical model. The initial physical model is an initial model of the physical property of the subsurface volume, wherein the initial model comprises initial physical property values for each of the cells of the first plurality of cells. The initial physical model may be a shear wave velocity model 300 as described above with reference to FIG. 6, and/or be an initial physical model having any of the features or variations described above with reference to FIG. 6. The initial model sets initial physical property values for each cell of the model, which the method 700 will refine using the group/phase velocity model obtained from iterative tomographic process 600 using a further iterative process. Accordingly, it is not essential for the initial physical model and initial physical property values to be a highly accurate or high-resolution model of the subsurface target volume, although a more accurate first model may increase the expected accuracy of the end result of the method or decrease the computational time to reach the end result.

In some examples, the initial physical model is determined based on a user input, e.g. according to historic data or map information indicating possible physical property values across the subsurface target volume. Alternatively, the initial physical model may be determined using the received signals, e.g. by performing an inversion of group velocity or phase velocity dispersion curves between geophones, which can be calculated from cross-correlation of the signals as described above, to find a using a coarser grid or quicker method. As a last resort, an arbitrarily chosen typical value of the physical property can be used for each cell as a starting point, which may be based on estimated physical properties of the subsurface target volume, In some examples, the initial physical model may be determined based on empirical phase dispersion data between source-receiver pairs. Phase velocity information is acquired as a point in 2D phase space (a dispersion spectrum) which may be obtained by a 2D transform of an array of waveforms (time-distance space), the transform may be Radon, slant-slack, FK or any other suitable methods apparent to the skilled person. The generation of dispersion curves showing the phase velocity as a function of frequency may provide a preliminary three-dimensional model of the shear velocities in a 3D model. However, since the acquisition of the phase velocity is essentially an average frequency-dependent velocity between measurement nodes, the resolution of this model is relatively low. Thus, a physical model derived solely from empirical phase dispersion data may be used as an initial model for an inversion which also takes into account empirical group dispersion data to obtain a more accurate final 3D model of the subsurface target volume.

Process 700 further comprises a step 704 of determining modelled surface wave velocities for each cell based on the initial model. In more detail, a forward modelling approach is used to derive the phase and/or group velocities for each cell of the initial physical model, using the respective physical property value for the given cell. For example, the physical property values of each cell may be a shear wave velocity. The values of shear wave velocity of for each cell can be used to calculate a corresponding phase velocity dispersion function (and thus a phase velocity for a given frequency) using the propagation matrix method introduced by Thomson ((1950). “Transmission of elastic waves through a stratified solid medium”, Journal of applied Physics, 21(2), 89-93) and Haskell ((1953) “The dispersion of surface waves on multilayered media”. Bulletin of the seismological Society of America, 43(1), 17-34). The skilled person would be well aware of this and other approaches that can be used to forward model group or phase velocities (or dispersion functions) from shear wave velocity values (or functions of depth).

The inversion process further comprises the step 706 of determining an error value indicative of the difference between the modelled velocities (determined at step 704 based on the initial physical model) and the empirical velocities (obtained from process 600) for each cell of the model. The error value may be determined for each cell in a similar manner to that described above in relation to step 606 in which an error value is determined between modelled and empirical traveltimes for each source-receiver pair. As with the tomographic process 600, in general determining the error value at step 706 is part of an iterative process, for example, in a least-squares inversion method where the squares of the residuals are calculated in order to be minimised through iterations. Other forms of inversion processes use different error values in order to provide feedback to the initial model of the physical properties of the subsurface target volume.

The process 700 further comprises the step 708 of determining an updated physical model based on the error value determined at step 706. The updated physical model is generally in all aspects the same as the initial physical model except for new physical property values associated with at least some of the cells. In other words, the updated model is an updated version of the initial physical model taking into account the determined error value between the empirical and modelled surface wave velocities for each cell of the model. This feedback process may involve a least-squares method, Markov-chain Monte Carlo method or other inversion technique to iteratively update the initial physical model based on an updated physical model.

Steps 704 to 708 are typically all part of a subroutine of the second-stage inversion process 700, which is then iterated according to the inversion method such as least-squares inversion. The iterative nature of the process 700 is illustrated by the dashed arrow in FIG. 8, which indicates that the updated model determined at step 708 is used to determine new surface wave velocities for each cell at 704. In other words, each time an updated model is determined using the error value resulting from the initial model and resulting modelled velocities for each cell, the resulting updated model is then used as the initial model for the next iteration. The iteration continues until the error value reaches an end condition, such as an end criterion described above in relation to FIG. 7.

An alternative tomographic inversion process 800 is now described with reference to FIG. 9. This tomographic inversion process is a single-stage process in which the tomography and inversion are combined. This means that the iterative inversion stage to find the physical property values for the model is carried out for each wave path between a respective source-receiver pair, rather than for each cell of the model. This means that the initial tomography stage (process 600) for mapping surface wave velocities between source-receiver pairs to cells is not required in the single-stage process 800 because the physical property model inversion process carries out the inversion on each wave path, rather than each cell. In other words, the two-stage tomographic inversion first uses traveltime tomography to map traveltime information along wave paths into surface wave velocity information for a grid of cells. The two-stage tomographic inversion then carries out a cell-by-cell inversion of the surface wave velocity information (surface wave velocity as a function of frequency) to obtain a corresponding shear wave velocity function (as a function of depth) for each cell. In contrast, as described below, the one-stage process carries out a direct inversion of the surface wave velocity information for each wave path (for each source-receiver pair) to obtain a shear wave velocity function for the wave path, which is tomographically mapped to each cell of the model.

Process 800 begins with obtaining an initial physical model in the same manner as described in relation to step 702 for FIG. 8. The initial model sets initial physical property values for each cell of the model, which the method 800 will refine using the empirical traveltime data for each source-receiver pair. In some examples, the initial physical model may be determined based on empirical phase dispersion data between source-receiver pairs.

The method 800 further comprises determining 804 an empirical dispersion function for each wave path (i.e. each source-receiver pair), in particular, each wave path selected in the selecting 506 part of the method. The dispersion function may be a group velocity dispersion function or a phase velocity dispersion function (or both may be used). The dispersion function may be determined as described above, according to any of the usual methods in the art.

The method 800 further comprises determining 806 a modelled dispersion function for each wave path using the first model. For example, the values of shear wave velocity of the first model can be used to calculate a phase velocity dispersion function using the propagation matrix method introduced by Thomson ((1950). “Transmission of elastic waves through a stratified solid medium”, Journal of applied Physics, 21(2), 89-93) and Haskell ((1953) “The dispersion of surface waves on multilayered media”. Bulletin of the seismological Society of America, 43(1), 17-34), using a model of a stack of homogenous layers with finite thickness (overlying a homogenous half-space).

In particular, this can be performed using any available solver using a modal approximation method, such as written by Herrmann ((2013) “Computer programs in seismology: An evolving tool for instruction and research” Seismological Research Letters, 84(6), 1081-1088). This approach computes the phase velocity Vphase for a particular frequency ω from a stack of homogeneous layers with finite thickness, i.e. a 1-dimensional velocity profile. The first step consists of establishing the boundaries of where the phase velocity will lie between, e.g. the minimum and maximum Vs present in the model. For an arbitrary value of w, a trial value of wavenumber k is then tested and iteratively changed with a set increment until the eigenvalue solution is found. This eigenvalue can subsequently be used to calculate the solution to the eigenfunction, which will be tested against an iteratively changing value of Vphase to find the root of the solution and therefore a phase velocity dispersion function.

Herrmann's modal approximation code takes as inputs a list of layered elastic parameters and the frequency values of interest and outputs a dispersion function as the solution of the eigenvalue problem defined by the matrix propagator method introduced by Haskell and Thomson. Herrmann's solver is widely used and available as a software package from Saint Louis University Earthquake Center, “Computer Programs in Seismology” page https://www.eas.slu.edu/eqc/eqccps.html, along with extensive manuals and instructions for using this software (in addition to the 2013 paper “Computer programs in seismology: An evolving tool for instruction and research” references above). Alternative solvers are also available via GitHub, such as https://github.com/xin2zhang/MCTomo based on 3D Monte Carlo tomography (Zhang, X., Curtis, A., Galetti, E., & de Ridder, S., 2018. “3-D Monte Carlo surface wave tomography”, Geophysical Journal International, 215(3), 1644-1658), or https://github.com/keurfonluu/disba by Keurfon Luu (also available at zenodo.org titled keurfonluu/disba: disba v0.5.1 and which, according to its documentation page, implements “a subset of codes from Computer Programs in Seismology (CPS) in Python compiled just-in-time with numba”.

In additional to or alternatively to shear wave velocity, other physical properties may be used which are related to shear wave velocity. For example, the longitudinal wave (P-wave) velocity Vp and shear wave (or transverse/S-wave) velocity Vs are related to other physical properties of the ground elastic modulus A, shear modulus p, and density p by the following equations from linear elasticity theory:

$$( longitudinal wave velocity )$$

$${V}_{p} = \sqrt{\frac{λ + 2 μ}{ρ}} \qquad Equation 1$$

$$( shear wave velocity )$$

$${V}_{s} = \sqrt{\frac{μ}{ρ}} \qquad Equation 2$$

In summary, there are established methods for determining a phase velocity dispersion function from a stack of homogenous layers (constant is x and y directions) with finite thickness and associated shear wave velocity values (or related physical properties) for each layer. Accordingly, one way to use the methods developed by Thomson and Haskell and Herrmann is to use multiple wave paths between geophones that intersect within a particular cell of the model and combine the dispersion functions of the wave paths to determine a dispersion relation for that particular cell. The dispersion relation for that cell can then be used for ‘inversion’ using the homogenous layers approach using the shear wave velocity values for that cell, i.e. refining the model values in that cell to better produce the dispersion relation found for that cell (and doing likewise for all cells individually). However, the inventors have developed a different approach wherein, instead of performing the inversion on each cell, the inversion is done for a whole wave path using the multiple shear wave velocity values in the cells that the wave path traverses. This approach has numerous advantages, including improved computational efficiency, allowing for geophone arrays with more geophones and/or higher resolution models, and increased accuracy of the model determination. For example, because the shear wave velocity model is refined in a single step from the dispersion functions found between geophones, this removes the extra step of the travel-time tomography using the wave paths for each cell, which is an extra source of approximation and therefore inaccuracies because the inversion is independent for each cell (therefore losing the interdependence of crossing wave paths in the inversion step). In addition to removing an extra step in the process, thereby reducing the amount of computational power needed, performing the inversion in a single step also means that a least-squares method can be used rather than more computationally intensive Monte-Carlo inversion methods. This in turn means that the inversion compute time is reduced or, for the same amount of compute time, more geophone signals can be processed or a higher resolution model can be produced.

In some examples, the determining 806 the modelled dispersion function for each wave path is performed by averaging the shear wave velocity values of the cells which that wave path traverses. In particular, for shear wave velocity, the 1/Vs values are averaged because the travel-time through each cell is inversely proportional to velocity. For other physical properties of the cells, such as density, a simple arithmetic mean of the values in each cell may be suitable. In either case, the values are still a function of depth. The averaged shear wave velocity (or other averaged physical property) is then used in the Herrmann modal approximation method to determine the modelled dispersion function for the whole wave path. This averaging process can be implemented in the solver software as an additional function prior to running the inversion routine.

In some examples, the averaging of the shear wave velocity values is a weighted average, weighted according to the ray segment length in each cell, as set out in equation 3, which applies to straight wave paths or curved wave paths. For wave paths represented by Fresnel zones, the weights will also include an additional term corresponding to the sensitivity of the wave path to variations in the local velocity at different parts of the Fresnel zone (i.e. there is higher sensitivity at the centre of the zone that the peripheries). Using a weighted average increases the accuracy of the calculation as it more closely corresponds to the actual values that the wave path will experience between the pair of geophones.

$$\frac{1}{{Vs}_{A \to B}} = \frac{1}{{L}_{A \to B}} {\sum }_{i = 1}^{N} {L}_{i} \frac{1}{{Vs}_{i}} \qquad Equation 3$$

where:
Vs_{A→B} is the average shear wave velocity for the wave path A to B (as a function of depth);
N is the number of cells of the first model that the wave path A to B traverses;
Lᵢ is the ray segment length of the i^{th} cell along the wave path;
L_{A→B} is the total wave path length from A to B, i.e. the sum of all Lᵢ;
Vsᵢ is the shear wave velocity value for the i^{th} cell along the wave path (as a function of depth).

In some examples, rather than first averaging the shear wave velocity values along the wave path length, the modal approximation method is performed to produce a dispersion function for each cell and then the cell dispersion functions for each cell which the wave path traverses are averaged to produce the modelled dispersion function for the wave path. This can be done by averaging 1/Vphase for phase velocity dispersion function (or conversely 1/Vgroup for group velocity dispersion function) for each cell along the wave path, optionally including weightings analogously to the averaging described above. This averaging process can be implemented in the solver software as an additional function after running the inversion routine

The method further comprises determining 808 an error value indicative of the difference between the modelled dispersion function (determined 806 from the model) and the empirical dispersion function (determined 804 from the detected signals) for each wave path (i.e. each source-receiver pair). The error value may be determined for each wave path a similar manner to that described above in relation to steps 606 and 706. As with the two-stage tomographic processes 600 and 700, in general determining the error value at step 808 is part of an iterative process, for example, in a least-squares inversion method where the squares of the residuals are calculated in order to be minimised through iterations. Other forms of inversion processes use different error values in order to provide feedback to the initial model of the physical properties of the subsurface target volume.

The process 800 further comprises the step 810 of determining an updated physical model based on the error value determined at step 808. The updated physical model is generally in all aspects the same as the initial physical model except for new physical property values associated with at least some of the cells. In other words, the updated model is an updated version of the initial physical model taking into account the determined error value between the empirical and modelled surface wave velocities for each cell of the model. This feedback process may involve a least-squares method, Markov-chain Monte Carlo method or other inversion technique to iteratively update the initial physical model based on an updated physical model.

In some examples, the determined error value indicates that the empirical dispersion function along a wave path shows larger values for phase velocity (or group velocity) than the modelled dispersion function, either across the function or in one or more frequency bands. Accordingly, this indicates that the values of shear wave velocity values along that wave path are less than the true physical properties of the subsurface target volume. As such, determining the second model using the error value comprises recording new shear wave velocity values for the cells which that wave path traverses which are greater than the corresponding values in the first model. Conversely, if the empirical dispersion function has smaller values than the modelled dispersion function, then the values of the shear wave velocity values along that wave path are greater than the true values in the subsurface volume and the model should be updated accordingly.

One way to update the first model to determine the second model is to find an empirical shear wave velocity average for the wave path through inversion of the dispersion function, and to scale each of the shear wave velocity values from the first model according to a difference between the empirical shear wave velocity average and the average shear wave velocity of the first model for that wave path. In more detail, the update factor for the first model for each wave path may be defined as the ratio of: the difference between the empirical shear wave velocity average and the average shear wave velocity of the first model for that wave path; and the average shear wave velocity of the first model for that wave path. In practice, this entails doing an arithmetic mean of 1/Vs, also referred to as the ‘slowness’, because cells with smaller shear wave velocity will have a bigger impact on the average shear wave velocity over the whole wave path. Optionally, the updating of the first model to produce the second model includes weighting the change to the shear wave velocity values for each cell according to the ray segment length of the wave path in that cell, according to the approach explained above with reference to determining 510 the modelled dispersion function part of the method 500.

In some examples, the shear wave values of the first model are updated to produce the second model using a sensitivity matrix method. In this approach, partial derivatives of the error value (or residual) are determined with respect to the shear wave velocity and/or other parameters of the first model, such as depth of boundaries between shear wave velocity values in a given cell, longitudinal wave velocity, density, etc. The partial derivatives are assembled into a sensitivity matrix and a linear system of equations is solved to determine how to change the parameters of the first model such that the overall error value is reduced for the second model with updated values.

Once the updates to the values of the first cell along a first wave path (e.g. a ray or a Fresnel zone) are calculated, these updates can be applied to produce the second model directly. Alternatively, the updates to values of all cells as influenced by each wave path calculation and inversion can be combined and applied to the values of the first model at once to produce the second model.

Steps 806 to 810 are typically all part of a subroutine of the single-stage tomographic inversion process 800, which is then iterated according to the inversion method such as least-squares inversion. The iterative nature of the process 800 is illustrated by the dashed arrow in FIG. 9, which indicates that the updated model determined at step 810 is used to determine new surface wave velocities for each cell at 806. In other words, each time an updated model is determined using the error value resulting from the initial model and resulting modelled velocities for each cell, the resulting updated model is then used as the initial model for the next iteration. The iteration continues until the error value reaches an end condition, such as an end criterion described above in relation to FIGS. 7 and 8.

With reference to FIG. 9, although the parts of the method 800 have been arranged and numbered in a sequence, the method is not limited to the particular order in which the parts are presented herein. As an example, there is no requirement for either the empirical dispersion function or the first modelled dispersion function to be performed before the other.

In some examples, once a final second model has been determined, e.g. once the iterations satisfy the end condition, the final second model may be sent to an output device. For example, the final second model may be displayed on a monitor or other user interface, or sent via wired or wireless communication to another computing device for further processing or display.

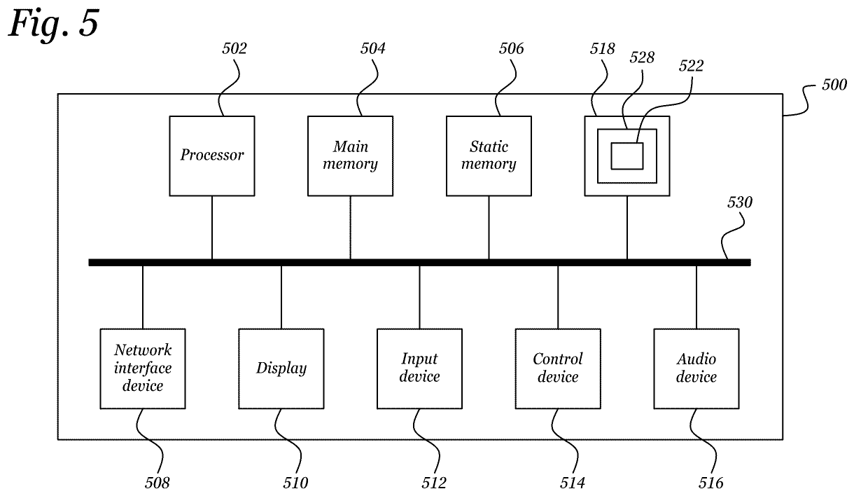

FIG. 5 shows a block diagram of one implementation of a computing device 500 within which a set of instructions, for causing the computing device to perform any one or more of the methodologies discussed herein, may be executed. In alternative implementations, the computing device may be connected (e.g., networked) to other machines in a Local Area Network (LAN), an intranet, an extranet, or the Internet. The computing device may operate in the capacity of a server or a client machine in a client-server network environment, or as a peer machine in a peer-to-peer (or distributed) network environment. The computing device may be a personal computer (PC), a tablet computer, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single computing device is illustrated, the term “computing device” shall also be taken to include any collection of machines (e.g., computers) that individually or jointly execute a set (or multiple sets) of instructions to perform any one or more of the methodologies discussed herein.

The example computing device 500 includes a processor 502, a main memory 504 (e.g., read-only memory (ROM), flash memory, dynamic random access memory (DRAM) such as synchronous DRAM (SDRAM) or Rambus DRAM (RDRAM), etc.), a static memory 506 (e.g., flash memory, static random access memory (SRAM), etc.), and a secondary memory (e.g., a data storage device 518), which communicate with each other via a bus 530.

Processor 502 represents one or more general-purpose processors such as a microprocessor, central processing unit, or the like. More particularly, the processor 502 may be a complex instruction set computing (CISC) microprocessor, reduced instruction set computing (RISC) microprocessor, very long instruction word (VLIW) microprocessor, processor implementing other instruction sets, or processors implementing a combination of instruction sets. Processor 502 may also be one or more special-purpose processors such as an application specific integrated circuit (ASIC), a field programmable gate array (FPGA), a digital signal processor (DSP), network processor, or the like. Processor 502 is configured to execute the processing logic (instructions 522) for performing the operations and steps discussed herein.

The computing device 500 may further include a network interface device 508. The computing device 500 also may include a video display unit 510 (e.g., a liquid crystal display (LCD) or a cathode ray tube (CRT)), an alphanumeric input device 512 (e.g., a keyboard or touchscreen), a cursor control device 514 (e.g., a mouse or touchscreen), and an audio device 516 (e.g., a speaker).

It will be apparent that some features of computer device 500 shown in FIG. 5 may be absent. For example, one or more computing devices 500 may have no need for display device 510 (or any associated adapters). This may be the case, for example, for particular server-side computer apparatuses 500 which are used only for their processing capabilities and do not need to display information to users. Similarly, user input device 512 may not be required. In its simplest form, computer device 500 comprises processor 502 and memory 504.

The data storage device 518 may include one or more machine-readable storage media (or more specifically one or more non-transitory computer-readable storage media) 528 on which is stored one or more sets of instructions 522 embodying any one or more of the methodologies or functions described herein. The instructions 522 may also reside, completely or at least partially, within the main memory 504 and/or within the processor 502 during execution thereof by the computer system 500, the main memory 504 and the processor 502 also constituting computer-readable storage media.

The various methods described above may be implemented by a computer program. The computer program may include computer code arranged to instruct a computer to perform the functions of one or more of the various methods described above. The computer program and/or the code for performing such methods may be provided to an apparatus, such as a computer, on one or more computer readable media or, more generally, a computer program product. The computer readable media may be transitory or non-transitory. The one or more computer readable media could be, for example, an electronic, magnetic, optical, electromagnetic, infrared, or semiconductor system, or a propagation medium for data transmission, for example for downloading the code over the Internet. Alternatively, the one or more computer readable media could take the form of one or more physical computer readable media such as semiconductor or solid state memory, magnetic tape, a removable computer diskette, a random access memory (RAM), a read-only memory (ROM), a rigid magnetic disc, and an optical disk, such as a CD-ROM, CD-R/W or DVD.

In an implementation, the modules, components and other features described herein can be implemented as discrete components or integrated in the functionality of hardware components such as ASICS, FPGAs, DSPs or similar devices.

A “hardware component” is a tangible (e.g., non-transitory) physical component (e.g., a set of one or more processors) capable of performing certain operations and may be configured or arranged in a certain physical manner. A hardware component may include dedicated circuitry or logic that is permanently configured to perform certain operations. A hardware component may be or include a special-purpose processor, such as a field programmable gate array (FPGA) or an ASIC. A hardware component may also include programmable logic or circuitry that is temporarily configured by software to perform certain operations.

Accordingly, the phrase “hardware component” should be understood to encompass a tangible entity that may be physically constructed, permanently configured (e.g., hardwired), or temporarily configured (e.g., programmed) to operate in a certain manner or to perform certain operations described herein.

In addition, the modules and components can be implemented as firmware or functional circuitry within hardware devices. Further, the modules and components can be implemented in any combination of hardware devices and software components, or only in software (e.g., code stored
or otherwise embodied in a machine-readable medium or in a transmission medium).

Unless specifically stated otherwise, as apparent from the following discussion, it is appreciated that throughout the description, discussions utilizing terms such as “receiving”, “determining”, “comparing”, “enabling”, “maintaining,” “identifying,” “generating” or the like, refer to the actions and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

It is to be understood that the above description is intended to be illustrative, and not restrictive. Many other implementations will be apparent to those of skill in the art upon reading and understanding the above description. Although the present disclosure has been described with reference to specific example implementations, it will be recognized that the disclosure is not limited to the implementations described, but can be practiced with modification and alteration within the spirit and scope of the appended claims. Accordingly, the specification and drawings are to be regarded in an illustrative sense rather than a restrictive sense. The scope of the disclosure should, therefore, be determined with reference to the appended claims, along with the full scope of equivalents to which such claims are entitled.

1. A method of determining ground properties of a sub-surface target volume using a 2 dimensional array of surface wave sensors, the method comprising:
determining a plurality of velocity dispersion profiles as a function of sensed surface wave frequency;
generating a 3 dimensional phase velocity dispersion profile from the plurality of velocity dispersion profiles;
determining a plurality of group velocity dispersion profiles as a function of sensed surface wave frequency;
generating a plurality of respective shear wave velocity models as a function of depth from the 3 dimensional phase velocity dispersion profile and each group velocity dispersion profile; and
generating a 3 dimensional shear wave velocity model as a function of depth from the plurality of respective shear wave velocity models.

2. The method of claim 1, wherein the plurality of group velocity dispersion profiles comprise 1 dimensional group wave velocity dispersion profiles.

3. The method of claim 1, wherein the respective shear wave velocity models comprise 1 dimensional shear wave velocity models.

4. The method of claim 1, wherein each group velocity dispersion profile is determined by measuring a time of flight between a source and a receiver.

5. The method of claim 4, wherein the source and receiver comprise synthetic transmission nodes and the group velocity is determined through cross correlation of received noise.

6. The method of claim 1, wherein the respective shear wave velocity models are generated by a joint inversion of the 3 dimensional phase velocity dispersion profile and each group velocity dispersion profile.

7. The method of claim 6, wherein the joint inversion comprises iteratively modifying a phase and group predicted profile to obtain a best match against determined phase and group profiles for a corresponding target volume region.

8. The method of claim 1, wherein the plurality of velocity dispersion profiles are created as a function of frequency.

9. The method of claim 1, wherein each respective shear wave velocity model is generated for a sensing location from the 3 dimensional phase velocity dispersion profile and a group velocity dispersion profile of the plurality of group velocity dispersion profiles for the sensing location.

10. The method of claim 1, wherein the surface wave sensors are one of geophones, velocimeters or accelerometers.

11. The method of claim 1, wherein sensed surface waves are at least one of ambient or actively generated surface waves.

12. (canceled)

13. A system comprising:
one or more processors; and
a memory storying instructions, which when executed by the one or more processors, cause the one or more processors to:
determine a plurality of velocity dispersion profiles as a function of sensed surface wave frequency;
generate a 3 dimensional phase velocity dispersion profile from the plurality of velocity dispersion profiles;
determine a plurality of group velocity dispersion profiles as a function of sensed surface wave frequency;
generate a plurality of respective shear wave velocity models as a function of depth from the 3 dimensional phase velocity dispersion profile and each group velocity dispersion profile; and
generate a 3 dimensional shear wave velocity model as a function of depth from the plurality of respective shear wave velocity models.

14. The system of claim 13, wherein the plurality of group velocity dispersion profiles comprise 1 dimensional group wave velocity dispersion profiles.

15. The system of claim 13, wherein the respective shear wave velocity models comprise 1 dimensional shear wave velocity models.

16. The system of claim 13, wherein each group velocity dispersion profile is determined by measuring a time of flight between a source and a receiver.

17. The system of claim 16, wherein the source and receiver comprise synthetic transmission nodes and the group velocity is determined through cross correlation of received noise.

18. The system of claim 13, wherein the respective shear wave velocity models are generated by a joint inversion of the 3 dimensional phase velocity dispersion profile and each group velocity dispersion profile.

19. The system of claim 18, wherein the joint inversion comprises iteratively modifying a phase and group predicted profile to obtain a best match against determined phase and group profiles for a corresponding target volume region.

20. The system of claim 13, wherein the plurality of velocity dispersion profiles are created as a function of frequency.

21. The system of claim 13, wherein each respective shear wave velocity model is generated for a sensing location from the 3 dimensional phase velocity dispersion profile and a group velocity dispersion profile of the plurality of group velocity dispersion profiles for the sensing location.
